(19) United States
(12) Patent Application Publication
(10) Pub. No.: US 2020/0110214 A1
(43) Pub. Date: Apr. 9, 2020

(54) BACKLIGHT UNIT AND DISPLAY DEVICE INCLUDING THE SAME

(71) Applicant: Samsung Display Co., Ltd., Yongin-si (KR)

(72) Inventors: Ju Youn SON, Yongin-si (KR); Tae Yong RYU, Yongin-si (KR); Jae Sul AN, Yongin-si (KR)

(21) Appl. No.: 16/447,649

(22) Filed: Jun. 20, 2019

(30) Foreign Application Priority Data
Oct. 8, 2018 (KR) 10-2018-0119815

(51) Int. Cl. F21V 8/00; G02F 1/1333

(52) U.S. Cl. CPC G02B 6/0063; G02F 1/1333; G02B 6/0076; G02F 2001/133342; G02B 6/0038; G02B 6/0036; G02B 6/005

(57) ABSTRACT

A display device may include: a backlight unit and liquid crystal panels, the backlight unit being between the liquid crystal panels. The backlight may include: at least one light source to generate light; light guide plates, the at least one light source being disposed at one side of the light guide plates, the light guide plates being to provide a path for the light from the light source; a color conversion layer disposed between the light guide plates, the color conversion layer being to generate transmitted light by converting a color of the light from the light source; and light emission layers, the light guide plates being between the light emission layers, the light emission layers being to reflect the light from the light source toward the color conversion layer, the light emission layers being to allow the transmitted light to pass through the light emission layers.

### CROSS-REFERENCE TO RELATED APPLICATION

This application claims priority to and the benefit of Korean patent application 10-2018-0119815 filed on Oct. 8, 2018 in the Korean Intellectual Property Office, the entire content of which is incorporated herein by reference.

### BACKGROUND

### 1. Field

The present disclosure generally relates to a backlight unit and a display device including the same.

### 2. Description of the Related Art

With the development of information technologies, the importance of a display device which is a connection medium between a user and information increases. Accordingly, display devices such as liquid crystal display devices and organic light emitting display devices are increasingly used.

Some display devices display a target image to a user by writing a data voltage for expressing a target grayscale level in each pixel, and allowing an organic light emitting diode to emit light or allowing light of a backlight unit to be polarized by controlling orientation of liquid crystals, corresponding to the data voltage.

Recently, a bidirectional display device capable of displaying an image at a front surface or back surface thereof has been developed.

### SUMMARY

Aspects of embodiments of the present disclosure are directed to a backlight unit and a display unit including the same, which can improve luminance and decrease a thickness thereof.

According to an embodiment of the present disclosure, there is provided a display device including: a backlight unit to provide a backlight to a front surface or back surface of the backlight unit; and liquid crystal panels, the backlight unit being between the liquid crystal panels, the liquid crystal panels being to control an intensity of the backlight, wherein the backlight unit includes: at least one light source to generate light; light guide plates, the light source being at one side of the light guide plates, the light guide plates being to provide a path for the light from the light source; a color conversion layer between the light guide plates, the color conversion layer being to generate transmitted light by converting a color of the light from the light source; and light emission layers, the light guide plates being between the light emission layers, the light emission layers being to reflect the light from the light source toward the color conversion layer, the light emission layers being to allow the transmitted light to pass through the light emission layers.

Each of the light guide plates may be formed of glass.

The color conversion layer may include: a quantum dot layer including a quantum dot particle to convert the color of the light from the light source; protective layers, the quantum dot layer being between the protective layers, the protective layers being to protect the quantum dot layer; and refractive layers, the protective layers being between the refractive layers, the refractive layers having a first refractive index.

Each of the light guide plates may have a second refractive index. The first refractive index is smaller than the second refractive index.

The first refractive index may be no less than 1 and no more than 1.25.

Each of the light emission layers may include: a pattern layer having at least one light emission pattern formed in a trapezoidal pyramid shape or a semi-cylindrical shape; and an adhesive layer to allow the pattern layer and the light guide plates to be adhered to each other.

Hemispherical grooves may be formed in one surface of the pattern layer.

Hexahedral grooves may be formed in one surface of the pattern layer.

Each of the light emission layers may include a base layer between the pattern layer and the adhesive layer.

The display device may further include a sealing member to seal side surfaces of the light guide plates, the color conversion layer, and the light emission layers.

The sealing member may not seal a light incident surface among the side surfaces of the light guide plates, the color conversion layer, and the light emission layers.

The sealing member may include a silver (Ag) component.

The backlight unit may further include optical layers, the light emission layers being between the optical layers, the optical layers being to generate the backlight by homogenizing the transmitted light.

The display device mar further include printing pattern layers located in a light incident area adjacent to the at least one light source, the printing pattern layers being to block the light from the light source incident on the light incident area from passing through.

The light emission layers may be between the printing pattern layers, and the printing pattern layers may be between the optical layers.

The optical layers may be between the printing pattern layers, and the printing pattern layers may be between the liquid crystal panels.

The light incident area may be in a non-display area in which no image is displayed.

According to another embodiment of the present disclosure, there is proided a backlight unit including: at least one light source to generate light; light guide plates, the light source being at one side of the light guide plates, the light guide plates being to provide a path for the light from the light source; a color conversion layer between the light guide plates, the color conversion layer being to generate transmitted light by converting a color of the light from the light source; and light emission layers, the light guide plates being between the light emission layers, the light emission layers being to reflect the light from the light source toward the color conversion layer, the light emission layers being to allow the transmitted light to pass through the light emission layers.

The color conversion layer may include: a quantum dot layer including a quantum dot particle to convert the color of the light from the light source; protective layers, the quantum dot layer being between the protective layers, the protective layers being to protect the quantum dot layer; and refractive layers, the protective layers being between the protective layers, the refractive layers having a refractive index.

The backlight unit and the display device including the same according to embodiments of the present disclosure can improve luminance. Also, the backlight unit and the display device including the same according to embodiments of the present disclosure can decrease a thickness thereof. Also, the display device according to embodiments of the present disclosure can display an image through the front surface or back surface thereof. Also, the display device according to embodiments of the present disclosure can reduce or prevent a light leakage phenomenon.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

FIG. 1 is a diagram illustrating a display device according to an embodiment of the present disclosure.

FIGS. 2A and 2B are diagrams illustrating structures of the display device according to embodiments of the present disclosure.

FIG. 3 is a diagram illustrating a color conversion layer according to an embodiment of the present disclosure.

FIGS. 4A and 4B are diagrams illustrating light emission layers according to embodiments of the present disclosure.

FIGS. 5A and 5B are diagrams illustrating a pattern layer according to an embodiment of the present disclosure.

FIGS. 6A and 6B are diagrams illustrating a pattern layer according to an embodiment of the present disclosure.

FIGS. 7A and 7B are diagrams illustrating a sealing member according to an embodiment of the present disclosure.

FIG. 8 is a diagram illustrating a liquid crystal panel according to an embodiment of the present disclosure.

FIG. 9 is a diagram illustrating a pixel according to an embodiment of the present disclosure.

### DETAILED DESCRIPTION

In the following detailed description, exemplary embodiments of the present disclosure have been shown and described, for purposes of illustration. As those skilled in the art would realize, the described embodiments may be modified in various suitable ways, all without departing from the spirit or scope of the present disclosure. Accordingly, the drawings and description are to be regarded as illustrative in nature and not restrictive.

Like numbers refer to like elements throughout, and duplicative descriptions thereof may not be provided. The thicknesses, ratios, and dimensions of elements may be exaggerated in the drawings for clarity. As used herein, the term “and/or” includes any and all combinations of one or more of the associated listed items.

It will be understood that, although the terms “first,” “second,” etc. may be used herein to describe one or more elements, these terms should not be construed as limiting such elements. These terms are only used to distinguish one element from another element. Thus, a first element could be alternately termed a second element without departing from the spirit and scope of the present disclosure. Similarly, a second element could be alternately termed a first element. Singular forms of terms are intended to include the plural forms as well, unless the context clearly indicates otherwise.

Moreover, spatially relative terms, such as “beneath,” “below,” “lower,” “above,” “upper,” and the like may be used herein for ease of description to describe one element's spatial relationship to another element(s) as illustrated in the drawings. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be further understood that the terms “includes” and “including,” when used in this disclosure, specify the presence of stated features, integers, acts, operations, elements, and/or components, but do not preclude the presence or addition of one or more other features, integers, steps, operations, elements, components, and/or groups thereof.

In the specification, when an element is referred to as being “on,” “connected to,” or “coupled to” another element, it can be directly connected or coupled to the other element or be indirectly connected or coupled to the other element with one or more intervening elements interposed therebetween. In addition, it will also be understood that when an element or layer is referred to as being “between” two elements or layers, it can be the only element or layer between the two elements or layers, or one or more intervening elements or layers may also be present. Further, some of the elements that are not essential to the complete understanding of the disclosure may be omitted for clarity.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

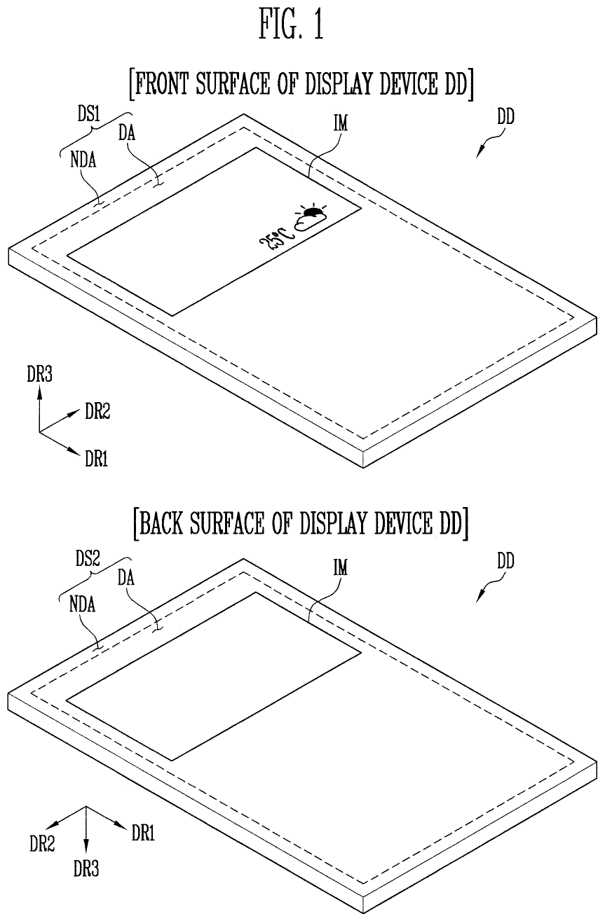

FIG. 1 is a diagram illustrating a display device DD according to an embodiment of the present disclosure.

As shown in FIG. 1, the display device DD may include a first display surface DS1 and a second display surface DS2. In some embodiments, the display device DD may be a dual display device (e.g., a device having two displays).

The first display surface DS1 may be located at a front surface of the display device DD, and the second display surface DS2 may be located at a back surface of the display device DD.

The display device DD may display images IM through the first display surface DS1 and the second display surface DS2. The first display surface DS1 and the second display surface DS2 may be parallel or substantially parallel to a plane defined by a first direction DR1 and a second direction DR2. A thickness direction of the display device DD with respect to the first display surface DS1 and the second display surface DS2 indicates a third direction DR3.

A front surface (or top surface) and a back surface (or bottom surface) of each member or unit described hereinbelow are distinguished by the third direction DR3. However, the first to third directions DR1, DR2, and DR3 illustrated in this embodiment are merely illustrative, and the directions indicated by the first to third directions DR1, DR2, and DR3 are relative concepts, and may be changed into other directions. Hereinafter, first to third directions are directions respectively indicated by the first to third directions DR1, DR2, and DR3, and are designated by like reference numerals.

In an embodiment of the present disclosure, the display device DD including a planar first display surface DS1 and a planar second display surface DS2 is illustrated, but the present disclosure is not limited thereto. The display device DD may include a curved display surface or a stereoscopic display surface.

The display device DD according to some embodiments of the present disclosure may be a rigid display device. However, the present disclosure is not limited thereto, and the display device DD according to embodiments of the present disclosure may be a flexible display device.

In an embodiment of the present disclosure, the display device DD applicable to a mobile phone terminal is exemplarily illustrated. Although not directly shown in the drawing, electronic modules, a camera module, a power module, and the like, which are mounted on a main board, are disposed together with the display device DD in a bracket/case, etc., thereby constituting a mobile phone terminal.

The embodiments of display devices DD according to the present disclosure may be applied to large-sized electronic devices such as televisions and monitors, and may also be applied to medium- or small-sized electronic devices such as tablet PCs, vehicle navigation systems, game consoles, smart watches, and head mounted displays.

Referring to FIG. 1, each of the first display surface DS1 and the second display surface DS2 may include a display area DA in which an image IM is displayed and a non-display area NDA adjacent to the display area DA. The non-display area NDA may be an area in which no image is displayed. In FIG. 1, an example image IM including temperature and weather images is illustrated.

As shown in FIG. 1, the display area DA may have a quadrangular shape. However, the present disclosure is not limited thereto, and each of the display area DA and the non-display area NDA may be designed in various shapes (e.g., a rhombus shape, a circular shape, an elliptical shape, and the like). The non-display area NDA may surround the display area DA, or may be around or at the edge of the display area DA.

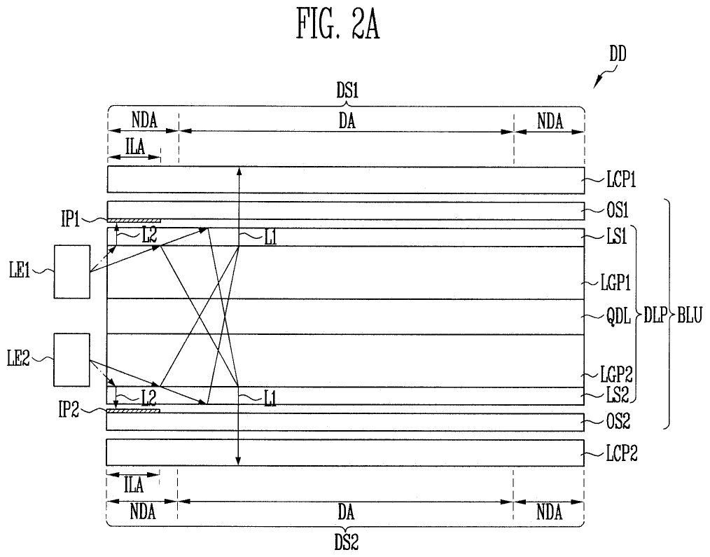

FIGS. 2A and 2B are diagrams illustrating structures of display devices DD according to embodiments of the present disclosure. Specifically, cross-sections of the display device DD according to embodiments of the present disclosure are illustrated in FIGS. 2A and 2B.

Referring to FIGS. 2A and 2B, the display device DD may include a first liquid crystal panel LCP1, a second liquid crystal panel LCP2, and a backlight unit BLU.

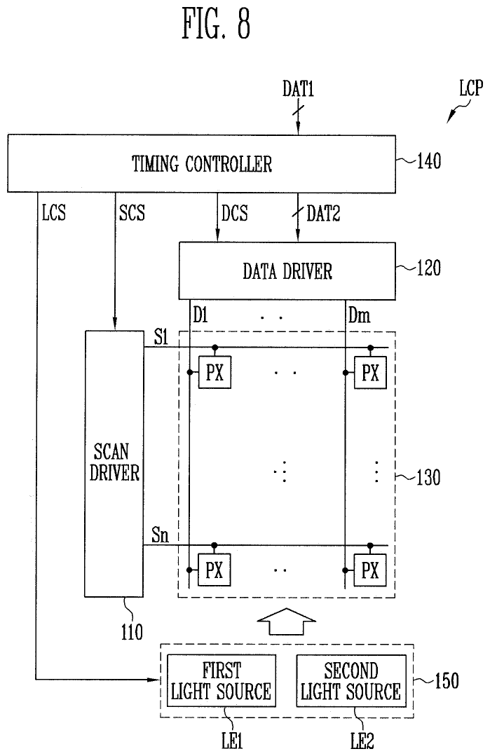

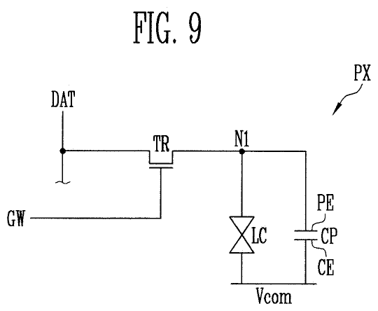

The first liquid crystal panel LCP1 and the second liquid crystal panel LCP2 may be disposed with the backlight unit BLU interposed therebetween. That is, the first liquid crystal panel LCP1 may be disposed at a front surface of the backlight unit BLU, and the second liquid crystal panel LCP2 may be disposed at a back surface of the backlight unit BLU. The first liquid crystal panel LCP1 and the second liquid crystal panel LCP2 may control the intensity of backlight supplied from the backlight unit BLU. This is described in more detail below with reference to FIGS. 8 and 9.

The backlight unit BLU may provide backlight to the first liquid crystal panel LCP1 and the second liquid crystal panel LCP2. The backlight unit BLU may be disposed between the first liquid crystal panel LCP1 and the second liquid crystal panel LCP2.

The backlight unit BLU may include a first optical layer OS1, a second optical layer OS2, at least one light source, and a light guide unit DLP. In FIGS. 2A and 2B, a backlight unit BLU including a first light source LE1 and a second light source LE2 is exemplarily illustrated.

The first optical layer OS1 and the second optical layer OS2 may be disposed with the light guide unit DLP interposed therebetween. That is, the first optical layer OS1 may be disposed at a front surface of the light guide unit DLP, and the second optical layer OS2 may be disposed at a back surface of the light guide unit DLP. The first optical layer OS1 and the second optical layer OS2 may generate backlight by homogenizing light from the light guide unit DLP.

The first light source LE1 may be disposed at one side of the light guide unit DLP, and the second light source LE2 may be disposed at the same one side of the light guide unit DLP. The first light source LE1 and the second light source LE2 may generate light and supply the generated light to the light guide unit DLP. In some embodiments, each of the first light source LE1 and the second light source LE2 may be a light emitting diode (LED).

The light guide unit DLP may allow the lights supplied from the first light source LE1 and the second light source LE2 to be incident on the first optical layer OS1 and the second optical layer OS2.

The light guide unit DLP may include a first light guide plate LGP1, a second light guide plate LGP2, a color conversion layer QDL, a first light emission layer LS1, and a second light emission layer LS2.

The first light guide plate LGP1 and the second light guide plate LGP2 may be at a side of the first light source LE1 and the second light source LE2. For example, the first light source LE1 may be at a side of the first light guide plate LGP1, and the second light source LE2 may be at a side of the second light guide plate LGP2, and in some embodiments the first light source LE1 is configured to emit light into the first light guide plate LGP1 and the second light source LE2 is configured to emit light into the second light guide plate LGP2. Also, the first light guide plate LGP1 and the second light guide plate LGP2 may be disposed with the color conversion layer QDL interposed therebetween. For example, the first light guide plate LGP1 may be disposed at a front surface of the color conversion layer QDL, and the second light guide plate LGP2 may be disposed at a back surface of the color conversion layer QDL. Each of the first light guide plate LGP1 and the second light guide plate LGP2 may be made of glass or polyethylene terephthalate (PET).

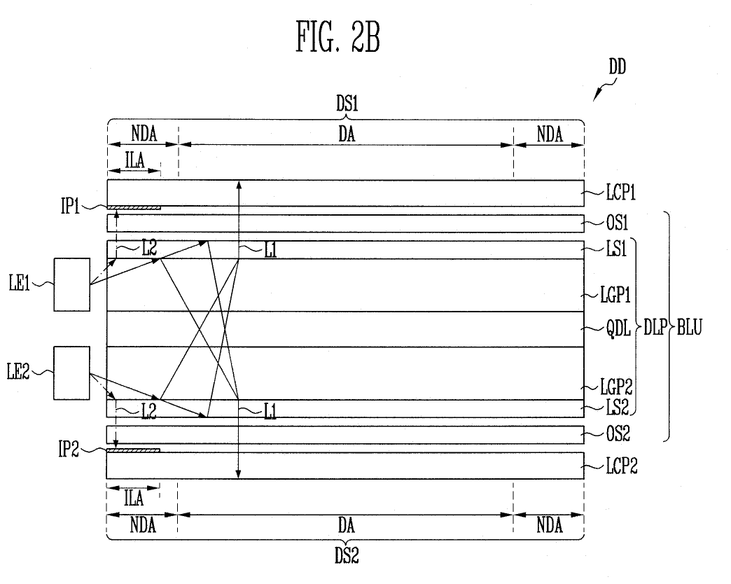

The color conversion layer QDL may be disposed between the first light guide plate LGP1 and the second light guide plate LGP2. The color conversion layer QDL may convert a color of light and generate transmitted light after the color is converted. For example, the color conversion layer QDL may include a quantum dot component. The color conversion layer QDL will be described in more detail with reference to FIG. 3.

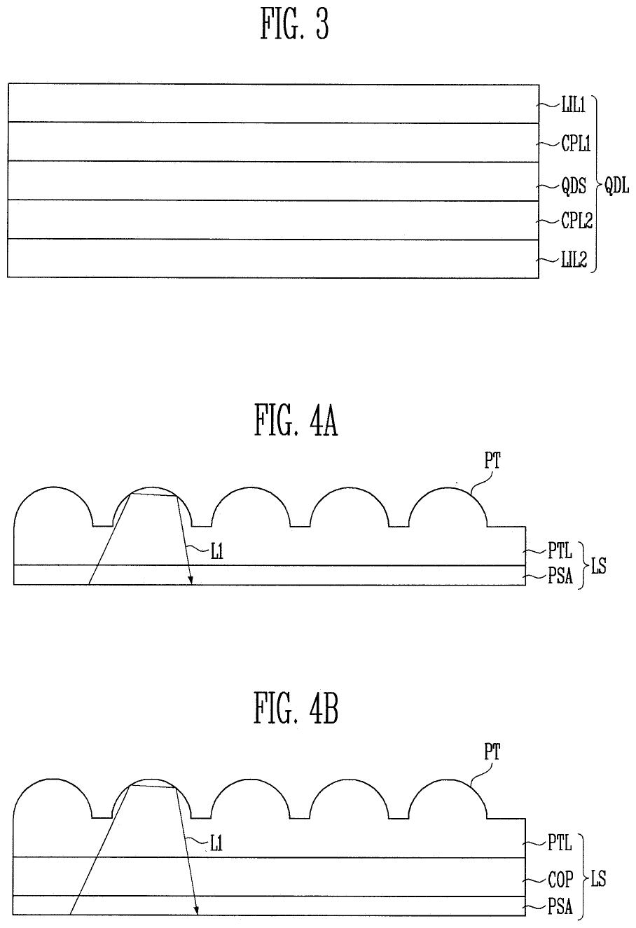

The first light emission layer LS1 and the second light emission layer LS2 may be disposed with the first light guide plate LGP1 and the second light guide plate LGP2 interposed therebetween. For example, the first light emission layer LS1 may be disposed at a front surface of the first guide plate LGP1, and the second light emission layer LS2 may be disposed at a back surface of the second light guide plate LGP2. The first light emission layer LS1 and the second light emission layer LS2 may reflect light toward the color conversion layer QDL or allow light transmitted through the color conversion layer QDL to pass through. The first light emission layer LS1 and the second light emission layer LS2 will be described in more detail with reference to FIGS. 4A and 4B.

The display device DD may further include a first printing pattern layer IP1 and a second printing pattern layer IP2. The first printing pattern layer IP1 and the second printing pattern layer IP2 may be located in light incident areas ILA adjacent to the first light source LE1 and the second light source LE2. In some embodiments, the light incident area ILA may be an area included in the non-display area NDA. The first printing pattern layer IP1 and the second printing pattern layer IP2 may block light incident on the light incident areas ILA from passing through.

According to the embodiment shown in FIG. 2A, the first printing pattern layer IP1 may be disposed between the first light emission layer LS1 and the first optical layer OS1, and the second printing pattern layer IP2 may be disposed between the second light emission layer LS2 and the second optical layer OS2. That is, the first printing pattern layer IP1 may be disposed at a back surface of the first optical layer OS1, and the second printing pattern layer IP2 may be disposed at a front surface of the second optical layer OS2.

According to the embodiment shown in FIG. 2B, the first printing pattern layer IP1 may be disposed between the first optical layer OS1 and the first liquid crystal panel LCP1, and the second printing pattern layer IP2 may be disposed between the second optical layer OS2 and the second liquid crystal panel LCP2. For example, the first printing pattern layer IP1 may be disposed at a back surface of the first liquid crystal panel LCP1, and the second printing pattern layer IP2 may be disposed at a front surface of the second liquid crystal panel LCP2.

Hereinafter, embodiments of each component will be described in more detail, based on advancing paths of lights generated by the first light source LE1 and the second light source LE2.

The first light source LE1 and the second light source LE2 may each generate first light L1 and second light L2.

The first light guide plate LGP1 may be supplied with the first light L1 and the second light L2 from the first light source LE1, and the second light guide plate LGP2 may be supplied with the first light L1 and the second light L2 from the second light source LE2.

The first lights L1 and the second lights L2 may advance in the first light guide plate LGP1 and the second light guide plate LGP2. In some embodiments, first light L1 and second light L2 may be defined by the angle at which the light is incident on the light emission layer proximate the light source emitting the light (e.g., LS1 for light emitted from LE1, and LS2 for light emitted from LE2), where first light L1 has a large angle of incidence relative to the second light L2. In some embodiments, second light L2 may be light incident at an angle which will not be reflected by the light emission layer.

The first light emission layer LS1 may reflect the first light L1 having a relatively large incident angle toward the color conversion layer QDL. A reflection angle (the angle at which the first light L1 is reflected from the first light emission layer LS1) may be smaller than the incident angle. A color of the first light L1 may be converted by the color conversion layer QDL. The first light L1 of which the color has been converted may advance toward the second light emission layer LS2, incident on the second emission layer LS2 with an angle corresponding to the reflection angle. The first light L1 may pass through the second emission layer LS2 and then advance toward the second display surface DS2.

The second light emission layer LS2 may reflect the first light L1 having a relatively large incident angle toward the color conversion layer QDL. A reflection angle (the angle at which the first light L1 is reflected from the second light emission layer LS2) may be smaller than the incident angle. A color of the first light L1 may be converted by the color conversion layer QDL. The first light L1 of which the color has been converted may advance toward the first light emission layer LS1, incident on the first emission layer LS1 with an angle corresponding to the reflection angle. The first light L1 may pass through the first emission layer LS1 and then advance toward the first display surface DS1.

The first light emission layer LS1 and the second light emission layer LS2 may allow the second lights L2 having a relatively small incident angle to pass therethrough. The second lights L2 may be generated in the light incident areas ILA adjacent to the first light source LE1 and the second light source LE2. The second light L2 may result in a light leakage phenomenon that light stronger than that of an adjacent area is emitted, a yellowish phenomenon where the color of light becomes yellowish, etc.

Therefore, the first printing pattern layer IP1 and the second printing pattern layer IP2 may be located in the light incident areas ILA and block the second light L2 so as to reduce or prevent occurrence of the phenomena.

FIG. 3 is a diagram illustrating a color conversion layer QDL according to an embodiment of the present disclosure.

Referring to FIG. 3, the color conversion layer QDL may include a quantum dot layer QDS, a first protective layer CPL1, a second protective layer CPL2, a first refractive layer LIL1, and a second refractive layer LIL2.

The quantum dot layer QDS may include a quantum dot particle for converting the color of transmitted light.

The first protective layer CPL1 and the second protective layer CPL2 may be disposed with the quantum dot layer QDS interposed therebetween. The first protective layer CPL1 and the second protective layer CPL2 may protect the quantum dot layer QDS. For example, each of the first protective layer CPL1 and the second protective layer CPL2 may have a single- or multi-layered structure. When each of the first protective layer CPL1 and the second protective layer CPL2 has the single-layered structure, each of the first protective layer CPL1 and the second protective layer CPL2 may include an inorganic layer. When each of the first protective layer CPL1 and the second protective layer CPL2 has the multi-layered structure, each of the first protective layer CPL1 and the second protective layer CPL2 may have at least one inorganic layer and at least one organic layer.

The first refractive layer LIL1 and the second refractive layer LIL2 may be disposed with the first protective layer CPL1 and the second protective layer CPL2 interposed therebetween. The first refractive layer LIL1 and the second refractive layer LIL2 may have a first refractive index. Meanwhile, the first light guide plate LGP1 and the second light guide plate LGP2, which are shown in FIGS. 2A and 2B, may have a second refractive index. For example, the first refractive index may be smaller than the second refractive index. In some embodiments, the first refractive index may belong to a range of no less than 1 and no more than 1.25.

FIGS. 4A and 4B are diagrams illustrating light emission layers LS according to embodiments of the present disclosure. The embodiments depicted in FIGS. 4A and 4B, may be any one of the first light emission layers LS1 and the second light emission layers LS2, which are shown in FIGS. 2A and 2B.

Referring to FIG. 4A, the light emission layer LS may include a pattern layer PTL and an adhesive layer PSA.

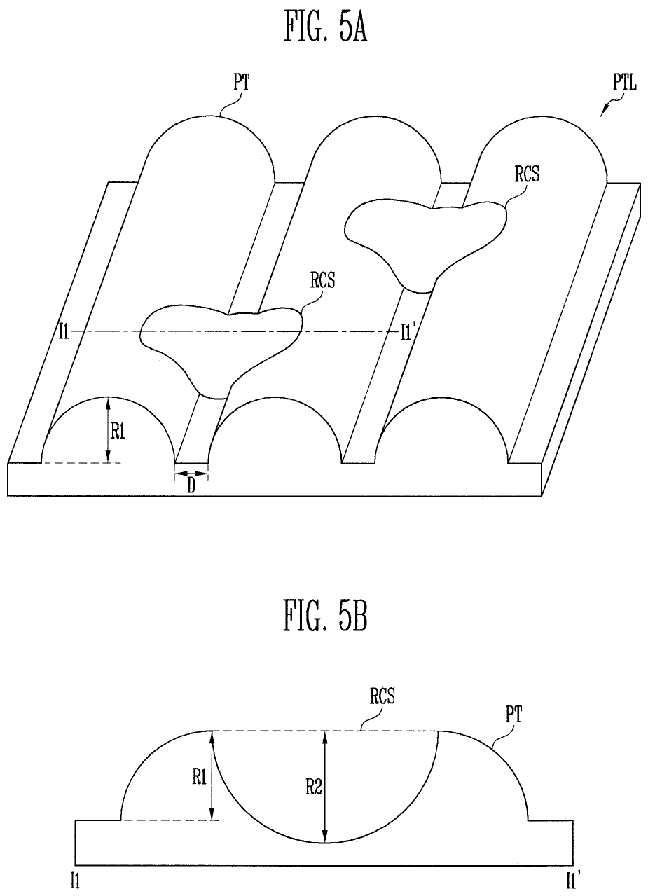

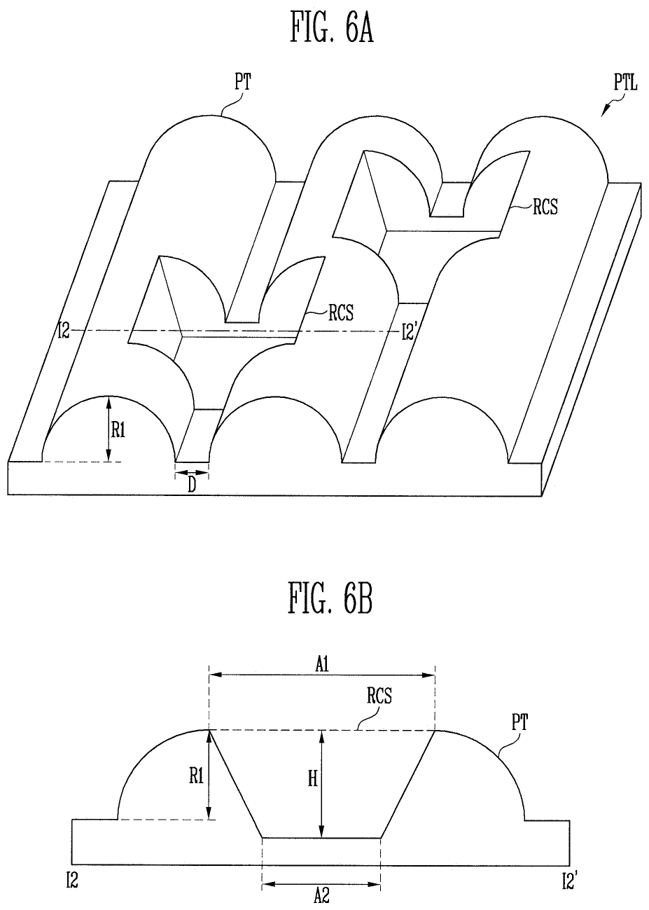

In some embodiments, the pattern layer PTL may have a semi-cylindrical pattern. This will be described in more detail with reference to FIGS. 5A to 6B. The shape of a pattern belonging to the pattern layer PTL according to the embodiment of the present disclosure is not limited thereto. In some embodiments, the pattern belonging to the pattern layer PTL may be formed in a triangular pyramid shape, a trapezoidal pyramid shape, etc.

The pattern layer PTL having the semi-cylindrical pattern is representatively described herein. However, it will be apparent to those skilled in the art that the following description may also be applied to embodiments in which the light emission layers include a pattern layer formed in a triangular pyramid shape, a trapezoidal pyramid shape, etc., and such embodiments are considered to be within the scope of the present disclosure.

For example, first light L1 may be reflected by the pattern. The adhesive layer PSA may allow the pattern layer PTL to be adhered to any one of the first light guide plate LGP1 (see FIGS. 2A and 2B) and the second light guide plate LGP2 (see FIGS. 2A and 2B). In some embodiments, the adhesive layer PSA may be a transparent adhesive member.

Referring to FIG. 4B, the light emission layer LS may include a pattern layer PTL, a base layer COP, and an adhesive layer PSA.

Hereinafter, differences between the light emission layer LS shown in FIG. 4B and the light emission layer LS shown in FIG. 4A will be mainly described to avoid redundancy. That is, the light emission layer LS according to the embodiment shown in FIG. 4B may further include the base layer COP, as compared with the light emission layer LS according to the embodiment shown in FIG. 4A.

The base layer COP may be disposed between the pattern layer PTL and the adhesive layer PSA. For example, the base layer COP may be a substrate for supporting the light emission layer LS.

FIGS. 5A and 5B are diagrams illustrating a pattern layer PTL according to an embodiment of the present disclosure. FIG. 5B illustrates a section taken along line of a pattern layer PTL shown in FIG. 5A.

Referring to FIGS. 5A and 5B, the pattern layer PTL may include light emission patterns PT. The light emission pattern PT may be arranged to be spaced apart from each other at a pattern distance D. For example, the light emission pattern PT may have a semi-cylindrical shape having a first radius R1.

The semi-cylindrical pattern PT is representatively described herein. However, it will be apparent to those skilled in the art that the following description may be applied to embodiments of patterns PT having other shapes, including formed in a triangular pyramid shape, a trapezoidal pyramid shape, etc., and those other shapes are within the scope of the present disclosure.

Grooves RSC may be formed in one surface of the pattern layer PTL. For example, the grooves RSC may have a hemispherical shape having a second radius R2. In some embodiments, the grooves RCS may be formed according to an arranged pattern. However, the present disclosure is not limited thereto, and the grooves RSC may be randomly formed.

In some embodiments, the first radius R1 and the second radius R2 may be different from each other. However, the present disclosure is not limited thereto, and the first radius R1 and the second radius R2 may be designed to have various values.

FIGS. 6A and 6B are diagrams illustrating a pattern layer PTL according to an embodiment of the present disclosure. FIG. 6B illustrates a section taken along line l2-l2′ of a pattern layer PTL shown in FIG. 6A.

Hereinafter, differences between the embodiment of FIGS. 6A and 6B and the embodiment of FIGS. 5A and 5B will be mainly described to avoid redundancy.

Grooves RCS may be formed in one surface of the pattern layer PTL. For example, the grooves RCS may have a hexahedral shape.

The cross-section of the groove RCS may have a trapezoidal shape. The length of a long side of the groove RCS may have a first length A1, and the length of a short side facing the long side may have a second length A2. In some embodiments, the first length A1 may be larger than the second length A2.

The distance between the long side and the short side of the groove RCS may be defined as a height H.

In some embodiments, the height H may be different from a first radius R1. However, the present disclosure is not limited thereto. The first radius R1, the first length A1, the second length A2, and the height H may be designed to have various values.

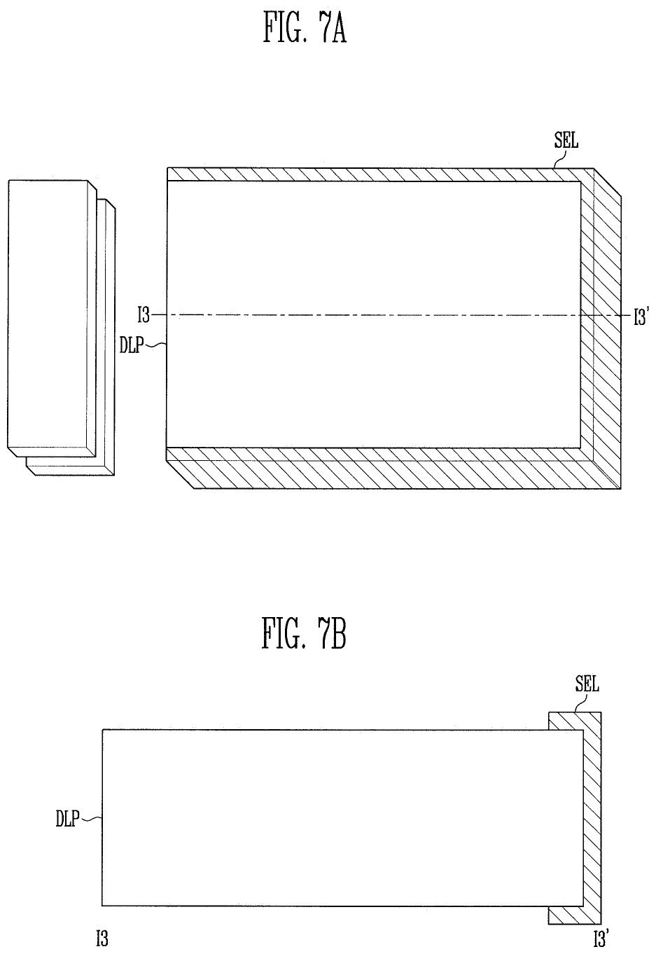

FIGS. 7A and 7B are diagrams illustrating a sealing member according to an embodiment of the present disclosure. FIG. 7B illustrates a section taken along line l3-l3′ of a light guide unit DLP shown in FIG. 7A.

In addition to the sealing member SEL, the light guide unit DLP, a first light source LE1, and a second light source LE2 are also illustrated for convenience of description. The light guide unit DLP may include the first light guide plate LGP1, the second light guide plate LGP2, the color conversion layer QDL, the first light emission layer LS1, and the second light emission layer LS2, shown in FIGS. 2A and 2B.

The sealing member SEL may seal side surfaces of the light guide unit DLP. For example, the sealing member SEL may seal each side surface of the light guide unit DLP other than a side surface (e.g., a light incident surface) facing the first light source LE1 and the second light source LE2. Also, the sealing member SEL may further seal a portion of the front surface and/or back surface of the light guide unit DLP, in addition to the side surfaces of the light guide unit DLP.

In some embodiments, the sealing member SEL may include a silver (Ag) component. The sealing member SEL may reflect light at a side surface (e.g., a light facing surface) of the light guide unit DLP. Thus, the sealing member SEL may reduce or prevent occurrence of a light leakage phenomenon at a boundary portion of the light guide unit DLP.

FIG. 8 is a diagram illustrating a liquid crystal panel LCP according to an embodiment of the present disclosure.

Referring to FIG. 8, the liquid crystal panel LCP may include a scan driver 110, a data driver 120, a pixel unit 130, a timing controller 140, and a light source unit 150.

The scan driver 110 may receive a scan control signal SCS from the timing controller 140. The scan driver 110 may generate scan signals based on the scan control signal SCS. The scan driver 110 may supply the scan signals to scan lines S1 to Sn (n is a natural number). For example, the scan driver 110 may sequentially supply the scan signals to the scan lines S1 to Sn. The scan signals may have a gate-on voltage. For example, when transistors supplied with the scan signals are of an N-type, the scan signals may have a high level voltage.

The data driver 120 may receive a data driving control signal DCS and second data DAT2 from the timing controller 140. The data driver 120 may generate data signals based on the data driving control signal DCS and the second data DAT2. The data driver 120 may supply the data signals to data lines D1 to Dm (m is a natural number). For example, the data driver 120 may supply the data signals to the data lines D1 to Dm in synchronization with a corresponding scan signal. The data signals supplied to the data lines D1 to Dm may be input to a pixel on a pixel line selected by the corresponding scan signal. In some embodiments, the data driver 120 may include a plurality of data driving integrated circuits (ICs).

Specifically, the data driver 120 may generate a data signal by sampling and latching second data DAT2 and then converting the second data DAT2 into an analog data voltage capable of expressing a grayscale. The data driver 120 may convert the second data DAT2 into a data signal in an analog grayscale voltage form, using a plurality of gamma reference voltages supplied from a gamma reference voltage generator.

The pixel unit 130 may include a substrate and pixels PX disposed on the substrate. In some embodiments, the pixel unit 130 may include at least one substrate and a liquid crystal layer. The pixel unit 130 may correspond to the display area DA shown in FIG. 1.

The pixels PX may be connected to corresponding scan lines S1 to Sn and corresponding data lines D1 to Dm. The pixels PX may be supplied with scan signals and data signals through the scan lines S1 to Sn and the data lines D1 to Dm. As shown in FIG. 8, the pixels PX may be disposed at intersection or crossing portions of the scan lines S1 to Sn and the data lines D1 to Dm.

The pixel unit 130 may further include the scan lines S1 to Sn and the data lines D1 to Dm, which are disposed on the substrate. In some embodiments, the scan lines S1 to Sn may extend in a first direction (e.g., a horizontal direction), and the data lines D1 to Dm may extend in a second direction (e.g., a vertical direction) different from the first direction. In some embodiments, any one of the pixels PX may be connected to at least one of the scan lines S1 to Sn, and be connected to at least one of the data lines D1 to Dm.

Meanwhile, although a case where the scan driver 110, the data driver 120, the pixel unit 130, and the timing controller 140 are components separate from each other is illustrated in FIG. 8, the present disclosure is not limited thereto. For example, at least two of the scan driver 110, the data driver 120, the pixel unit 130, and the timing controller 140 may be integrated as a single body or be mounted on the substrate of the pixel unit 130.

In some embodiments, the pixel unit 130 may be a liquid crystal display panel.

The pixels PX may control the intensity of backlight provided from the light source unit 150 based on a data signal. This will be described in detail with reference to FIG. 9.

The timing controller 140 may control overall operations of the liquid crystal panel LCP.

Specifically, the timing controller 140 may receive first data DAT1 and external control signals from the outside. For example, the first data DAT1 may represent an image received from the outside. The external control signals may include a vertical synchronization signal, a horizontal synchronization signal, a main clock signal, a data enable signal, and the like.

The timing controller 140 may compensate for the first data DAT1, based on compensation data. For example, the compensation data may include mura compensation values of the respective pixels PX.

The timing controller 140 may generate the second data DAT2 by compensating for the first data DAT1. Also, the timing controller 160 may generate the data driving control signal DCS, the scan control signal SCS, and a light source control signal LCS, based on at least one of the first data DAT1 and the external control signals. The second data DAT2, the data driving control signal DCS, the scan control signal SCS, and a light source control signal LCS may be suitable for an operating condition of the scan driver 110, the data driver 120, the pixel unit 130, and the light source unit 150.

The timing controller 140 may transmit the scan control signal SCS to the scan driver. The timing controller 140 may transmit the second data DAT2 and the data driving control signal DCS to the data driver 120. The timing controller 140 may transmit the light source control signal LCS to the light source unit 150.

The light source unit 150 may be driven based on the light source control signal LCS received from the timing controller 140.

The light source unit 150 may include the first light source LE1 and the second light source LE2, which may be those shown in FIGS. 2A and 2B. To avoid redundancy, refer to the description of the first light source LE1 and the second light source LE2 described above with respect to FIGS. 2A and 2B. The light source unit 150 may allow backlight to be incident on a back surface of the substrate of the pixel unit 130, with reference to the contents illustrated above in reference to FIGS. 2A and 2B.

FIG. 9 is a diagram illustrating a pixel PX according to an embodiment of the present disclosure.

Referring to FIG. 9, the pixel PX may include a transistor TR, a liquid crystal cell LC, and a capacitor CP.

The transistor TR may be connected between a corresponding data line and a first node N1, and a gate electrode of the transistor TR may be connected to a corresponding scan line. That is, when a corresponding scan signal GW is supplied to the scan line, the transistor TR may be turned on. When the transistor TR is turned on, a data signal DAT supplied to the corresponding data line may be supplied to the first node N1.

The first node N1 is a node commonly connected to the transistor TR, the liquid crystal cell LC, and the capacitor CP, and may be connected to a pixel electrode PE of the capacitor CP.

The liquid crystal cell LC and the capacitor CP may be connected between the first node N1 and a common power source Vcom. The common power source Vcom may supply a common voltage to the liquid crystal cell LC and the capacitor CP through a common electrode CE of the liquid crystal cell LC and the capacitor CP.

The liquid crystal cell LC and the capacitor CP may include the pixel electrode PE connected to the first node N1 and the common electrode CE connected to the common power source Vcom.

When the transistor TR is turned on, the data signal DAT supplied to the corresponding data line may be supplied to the first node N1.

The common voltage of the common power source Vcom may be supplied to the common electrode CE of the liquid crystal cell LC, so the voltage across the liquid crystal cell LC is the difference between the voltage supplied to the first node N1 and the common voltage. Thus, when the arrangement of liquid crystal molecules of the liquid crystal cell LC is changed by an electric field between the pixel electrode PE and the common electrode CE, the intensity of backlight supplied from the light source unit 150 shown in FIG. 8 can be controlled. Accordingly, a grayscale corresponding to the data signal can be expressed.

Meanwhile, the data signal supplied via the transistor TR may be stored in the capacitor CP. To this end, the capacitor CP may be connected between a second electrode of the transistor TR and the common electrode, or be connected between the second electrode of the transistor TR and a previous scan line, etc. The capacitor CP may constantly maintain or substantially maintain the voltage across the liquid crystal cell LC until a data signal of a next frame is supplied.

The electronic or electric devices and/or any other relevant devices or components (such as, for example, the timing controller 140, data driver 120, and/or scan driver 110) according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

A backlight unit and a display device including the same according to embodiments of the present disclosure can improve luminance. Also, the backlight unit and the display device including the same according to embodiments of the present disclosure can decrease a thickness thereof. Also, the display device according to embodiments of the present disclosure can display an image through the front surface or back surface thereof. Also, the display device according to embodiments of the present disclosure can prevent a light leakage phenomenon.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims and equivalents thereof.

What is claimed is:

1. A display device comprising:
a backlight unit to provide a backlight to a front surface or back surface of the backlight unit; and
liquid crystal panels, the backlight unit being between the liquid crystal panels, the liquid crystal panels being to control an intensity of the backlight,
wherein the backlight unit comprises:
light sources to generate light;
light guide plates, the light sources being at one side of the light guide plates, the light guide plates being to provide a path for the light from the light sources;
a color conversion layer between the light guide plates, the color conversion layer being to generate transmitted light by converting a color of the light from the light sources; and
light emission layers, the light guide plates being between the light emission layers, the light emission layers being to reflect the light from the light sources toward the color conversion layer, the light emission layers being to allow the transmitted light to pass through the light emission layers.

2. The display device of claim 1, wherein each of the light guide plates is formed of glass.

3. The display device of claim 1, wherein the color conversion layer comprises:
a quantum dot layer comprising a quantum dot particle to convert the color of the light from the light sources;
protective layers, the quantum dot layer being between the protective layers, the protective layers being to protect the quantum dot layer; and
refractive layers, the protective layers being between the refractive layers, the refractive layers having a first refractive index.

4. The display device of claim 3, wherein each of the light guide plates has a second refractive index, and
wherein the first refractive index is smaller than the second refractive index.

5. The display device of claim 4, wherein the first refractive index is no less than 1 and no more than 1.25.

6. The display device of claim 3, wherein each of the light emission layers comprises:
a pattern layer having at least one light emission pattern formed in a trapezoidal pyramid shape or a semi-cylindrical shape; and
an adhesive layer to allow the pattern layer and the light guide plates to be adhered to each other.

7. The display device of claim 6, wherein hemispherical grooves are formed in one surface of the pattern layer.

8. The display device of claim 6, wherein hexahedral grooves are formed on one surface of the pattern layer.

9. The display device of claim 6, wherein each of the light emission layers further comprises a base layer between the pattern layer and the adhesive layer.

10. The display device of claim 1, further comprising a sealing member to seal side surfaces of the light guide plates, the color conversion layer, and the light emission layers.

11. The display device of claim 10, wherein the sealing member does not seal a light incident surface among the side surfaces of the light guide plates, the color conversion layer, and the light emission layers.

12. The display device of claim 10, wherein the sealing member comprises a silver (Ag) component.

13. The display device of claim 1, wherein the backlight unit further comprises optical layers, the light emission layers being between the optical layers, the optical layers being to generate the backlight by homogenizing the transmitted light.

14. The display device of claim 13, further comprising printing pattern layers located in a light incident area adjacent to the light sources, the printing pattern layers being to block the light from the light sources incident on the light incident area from passing through.

15. The display device of claim 14, wherein the light emission layers are between the printing pattern layers, and the printing pattern layers are between the optical layers.

16. The display device of claim 14, wherein the optical layers are between the printing pattern layers, and the printing pattern layers are between the liquid crystal panels.

17. The display device of claim 14, wherein the light incident area is in a non-display area in which no image is displayed.

18. A backlight unit comprising:
light sources to generate light;
light guide plates, the light sources being at one side of the light guide plates, the light guide plates being to provide a path for the light from the light sources;
a color conversion layer between the light guide plates, the color conversion layer being to generate transmitted light by converting a color of the light from the light sources; and
light emission layers, the light guide plates being between the light emission layers, the light emission layers being to reflect the light from the light sources toward the color conversion layer, the light emission layers being to allow the transmitted light to pass through the light emission layers.

19. The backlight unit of claim 18, wherein the color conversion layer comprises:
a quantum dot layer comprising a quantum dot particle to convert the color of the light from the light sources;
protective layers, the quantum dot layer being between the protective layers, the protective layers being to protect the quantum dot layer; and
refractive layers, the protective layers being between the protective layers, the refractive layers having a refractive index.
